(19) United States
(12) Patent Application Publication
(10) Pub. No.: US 2010/0240437 A1
(43) Pub. Date: Sep. 23, 2010

(54) GAMING MACHINE WITH UNIVERSE OF PRESELECTED OUTCOMES WITH METHOD FOR DETERMINING PRESELECTED OUTCOMES

(75) Inventors: Richard Ditton, Kildeer, IL (US); Lawrence Hodgson, Kildeer, IL (US); Leif Marwede, Las Vegas, NV (US); Len Smikun, Glenview, IL (US)

Correspondence Address: Incredible Technologies, Inc., 3333 North Kennlcott Avenue, Arlington Heights, IL, 60004, US

(73) Assignee: Incredible Technologies, Arlington Heights, IL (US)

(21) Appl. No.: 12/708,713

(22) Filed: Feb. 19, 2010

Related U.S. Application Data
(60) Provisional application No. 61/161,976, filed on Mar. 20, 2009.

(51) Int. Cl. A63F 9/24; A63F 13/00

(52) U.S. Cl. 463/20; 463/25; 463/30

(57) ABSTRACT

A method for constructing paytables for gambling games is disclosed. Specifically, a method of defining a universe of possible outcomes, populating a sub-universe of winning outcomes, and efficiently populating the remainder of the universe with non-winning outcomes based on the desired behavior of the game is described. A means of further enhancing the creation of the sub-universe of winning outcomes to control volatility is also disclosed. Further, a means of controlling the sub-universe of non-winning outcomes to avoid non-desirable patterns of loss, including but not limited to “anti-lure” controls, is disclosed. A gambling machine utilizing the paytables constructed by the method is also disclosed.

### OBJECTS OF THE INVENTION

An object of the invention is to provide a simplified method for determining random outcomes of a game.

A second object of the invention is to provide a method for determining random outcomes of a game within a predetermined universe of possible outcomes.

A second object of the invention is to provide a highly granular method of determining the universe of possible outcomes for a game based on predetermined payout percentages and known variables.

A third object of the invention is to provide a method of determining the outcome of a gambling game which is highly adaptable to a variety of different game rules.

A fourth object of the invention is to provide a gambling machine utilizing the universe(s) of possible outcomes generated by the method.

Other objects and advantages of the invention will become apparent in the following disclosure.

### SUMMARY OF THE INVENTION

The present invention relates to games which are based on random selection, although it could be practiced with a game which also incorporated skill-based factors. In a game with multiple possible outcomes having varying values based upon the random selection of multiple game elements, a predetermined set of possible winning outcomes is constructed based on all possible wining permutations of the random selections inherent in the game. A universe of possible outcomes is then populated with the predetermined set of winning outcomes and additional non-winning outcomes in proportions designed to produce a predetermined winning ratio and a predetermined volatility for the game's outcomes. When the game is played, a single random selection from the universe of possible outcomes is made, determining the outcome of the game in a single step, but producing only outcomes which the game's rules could have produced by multiple random selections of game elements. Additional random selection of potential intermediate steps to the outcome may also be employed to enhance the player's enjoyment of the game.

### BRIEF DESCRIPTION OF THE DRAWINGS

The characteristic features of the invention will be particularly pointed out in the claims. The descriptions of the preferred embodiment refer to the preceding drawings:

FIG. 1 is a flow chart showing the method used to select the universe of possible outcomes used by the gambling game.

FIG. 2 is a table showing a first universe of possible outcomes selected by the method disclosed in the application.

FIG. 3 is a table showing a second universe of possible outcomes selected by the method disclosed in the application.

### DESCRIPTION OF THE PREFERRED EMBODIMENT

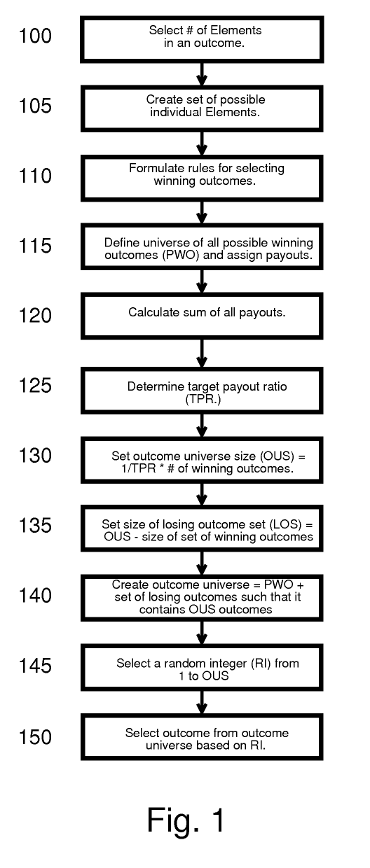

The description of the preferred embodiment uses the invention in a gaming apparatus of the type usually referred to as a “slot machine.” It could be used in any desired gaming or entertainment device, including but not limited to such things as a video poker game, a video keno game, a combination gaming machine, or even a coin-operated or bartop amusement device. In this description, the term “pull” should be understood to be one event during which the player places a bet of some fixed size and a random outcome determines whether the player loses their bet or receives it or some multiple of it back in the form of a payout. Typically a pull is based upon a bet fixed in some relevant currency, but may also be set in abstract “credits,” which simply represent some fixed unit in which to denominate bets, and whose value may be fixed or variable in terms of eventual prize payouts in currency. The description assumes that each pull is related to a bet of some number of credits, but any equivalences (currency units instead of credits, “hands” of poker instead of pulls) may be substituted into the invention. By referring to FIG. 1, the basic concept of the invention may easily be understood.

In Step 100, the number of individual elements which will be displayed are selected. For purposes of illustration, here six elements E1, E2, E3, E4, E5 and E6 are chosen, with the first three selected as a subset R1 and the second three selected as a subset R2. It should be noted that the method of the invention is infinitely scalable and may be applied to any number of elements and any selection of a subset of those elements (including the entire set of selected elements) as a winning combination.

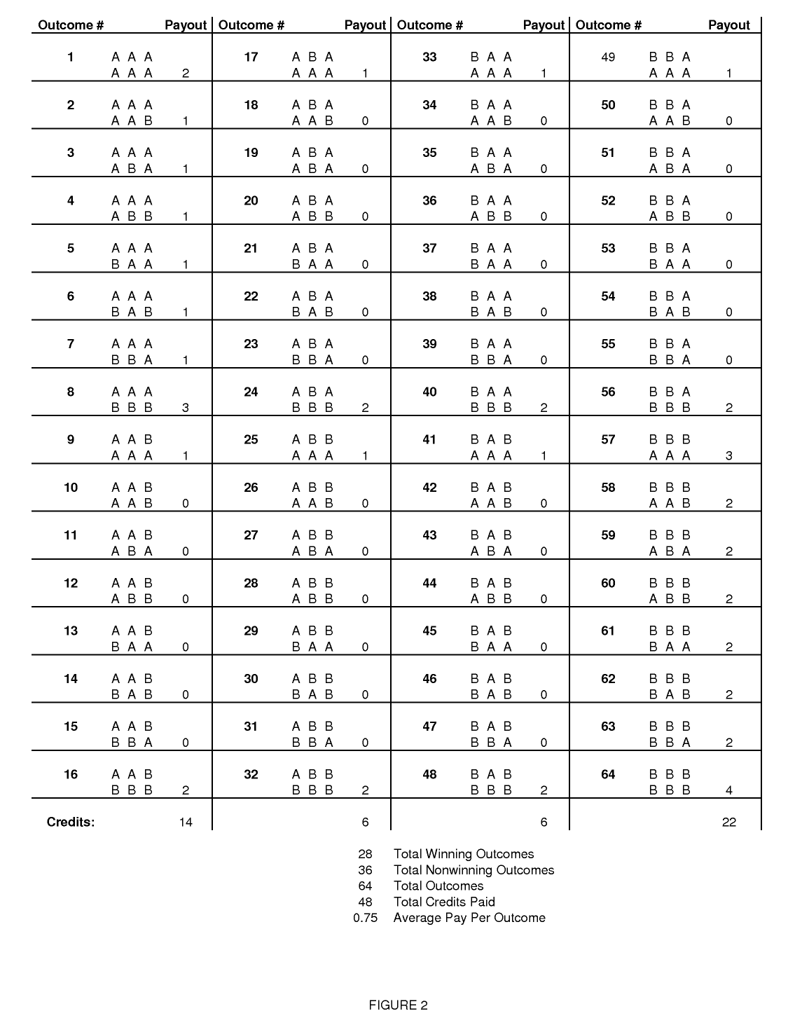

In Step 105, the number of possible selections for each element are selected. For purposes of illustration, here each element may be chosen from a universe of two possibilities, A and B. FIG. 2 shows all possible outcomes of such a game.

In Step 110, the parameter(s) for determining whether an outcome is a winning outcome or a non-winning outcome are determined: these parameters are the “rules” of the gambling game. In the description of this embodiment, any outcome which results in R1 and/or R2 having all selected elements be the same is selected as a winning outcome: all other outcomes are non-winning outcomes. Simple probability analysis, obvious to one of ordinary skill in the relevant art, reveals that given the illustration parameters, there are 2⁶ or 64 possible outcomes (a mathematician would refer to these as “permutations,”) of which twenty-eight are winning outcomes and the remaining thirty-six are non-winning outcomes.

It should be noted here that historically, gambling games involving similar methods randomly selected each element and compared the resulting set of element outcomes against a system of rules to determine whether an outcome was a winning one, and up to this point the method of the invention is similar to the methods of previous gambling games. For instance, a three-reeled slot machine might pay on all combinations in which all three selected symbols were the same. This method has several weaknesses which are addressed by the following steps of the method taught by the invention. First, it requires multiple random element selection facilities. Secondly, it requires a more or less elaborate method of comparing the outcome to the predetermined rules to evaluate the result on each pull. (This becomes much more burdensome in, for instance, a video poker game which has five selected elements from a universe of 52 or more cards.) Thirdly, it requires configuring the universe of winning outcomes and selected elements through a very time-consuming process, which cannot be mathematically simplified, in order to produce a desired payout percentage (defined as the total amount of overall wagers, over significant numbers of pulls, which are returned to the player as winnings) and a desired volatility (defined as the frequency of winning outcomes.) The relationship between payout percentage, volatility, and the respective universes of selected elements and possible outcomes must be refined through trial and error, and furthermore is subject to a variety of legal proscriptions in various jurisdictions. These problems should be kept in mind while reading the description of the preferred embodiment of the invention.

In Step 115, a set of preselected winning outcomes is created by selecting a plurality of outcomes which are deemed to be “winning” outcomes under the rules of the gambling game. It is strongly preferred that the set of preselected winning outcomes include at least one of each possible winning permutation of elements, but it is not required. It should be noted that the gaming regulations of many jurisdictions require that it be possible to achieve any theoretically possible winning outcome of a gambling game, hence the preference. Each preselected winning outcome is also assigned a payout amount in credits. It is preferred, but not required, that the payout amount for a winning outcome be logically related to its relative odds of selection, as this makes later operations simpler and more consistent. In the described embodiment, there are twenty-eight preselected winning outcomes shown in FIG. 2, each with the indicated payout in credits. (An outcome with a nonzero payout is a winning outcome.) In this illustration the set of preselected winning outcomes includes all possible winning outcomes, as stated the preferred configuration, and includes each one only once.

In Step 120, the total of all winning payout possibilities is determined by adding the payouts for each possible winning outcome. In the described embodiment, the total is 48 credits.

In Step 125, a target payout percentage is determined. This is the ratio of credits that are to be returned to the player over time as winnings to the ratio of credits that the player wagers. For purposes of illustration the target payout percentage selected is 50%. That is, the player will win 50 credits for every 100 they wager over a statistically significant number of pulls. This percentage may be less than or greater than 100, although in ordinary practice it will be greater than zero and less than 100, or the gambling game would either never pay on a wager or would not be profitable to operate. Many jurisdictions also have legally mandated minimum required payout percentages for gambling games.

In Step 130, the inverse of the payout percentage, described as a fraction, is multiplied by the total of all winning payout possibilities to obtain a target outcome universe size. In the described embodiment this is 2/1 (the inverse of ½ or 50%) times 48 or 96.

In Step 135, the number of possible winning outcomes is subtracted from the target outcome universe size to determine a target non-winning outcome subset size. In the described embodiment this is 96-28 or 66 non-winning outcomes.

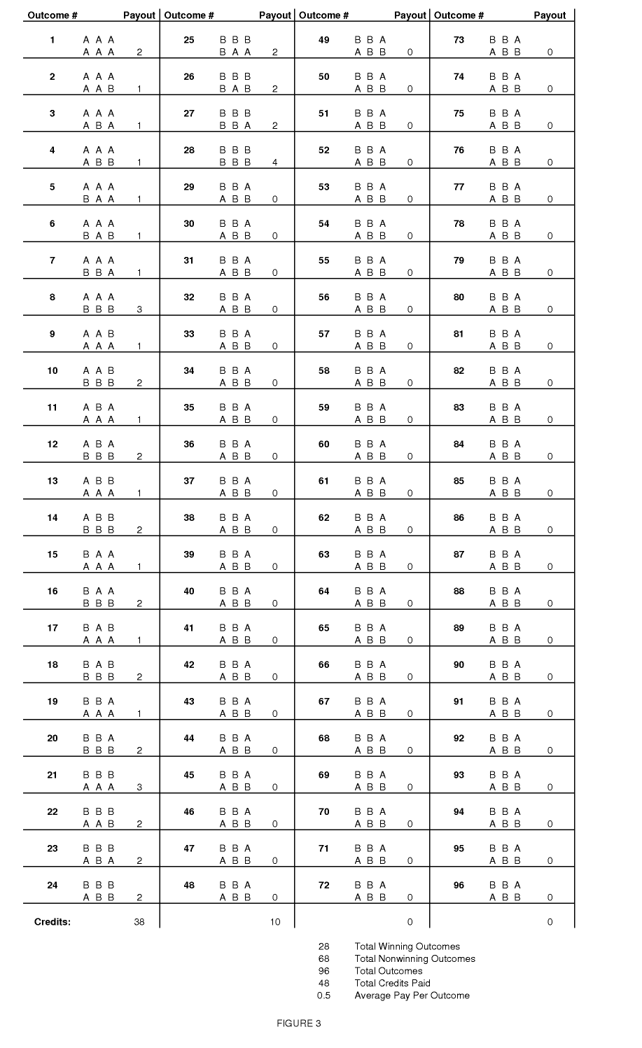

In Step 140, an outcome universe is created by adding the set of all possible winning outcomes to a set of preselected non-winning outcomes equal in number to the target non-winning outcome subset size. The key fact about the set of preselected non-winning outcomes is not what any particular non-winning outcome happens to be, but that the set of preselected non-winning outcomes contains only non-winning outcomes. The individual preselected non-winning outcomes need not be unique nor need their distribution bear any relationship at all to the actual likelihood of selecting that individual non-winning outcome if the individual elements of a non-winning outcome were randomly selected. For purposes of the described embodiment, all preselected non-winning outcomes are identical. FIG. 3 shows the outcome universe of the described embodiment.

In Step 145, an outcome-determining random number is selected from a discrete range which maps onto a set of integers equal in size to the number of elements in the outcome universe. The actual method of selecting the outcome-determining random number is unimportant but it is required that it be selected randomly from a set which can be mapped on a 1:1 basis to the total number of elements in the outcome universe. Here the random number is a number from 1 to 96.

In Step 150, the outcome-determining random number is used to select the corresponding outcome from the outcome universe. The single selection of the outcome-determining random number thus substitutes for selecting discrete elements. The advantage of this method with regard to calculation is that all steps to this point can be done once, in advance, and the results stored as a selectable paytable (or set of possible outcomes corresponding to a given gambling game) in an electronic gaming machine. Further refinements to the method, detailed below, also provide significant time and storage space utilization in such an electronic gaming machine, but while they are preferred they are not required.

In Step 155, the player is informed of the results of the pull by displaying the possible outcome corresponding to the outcome-determining random number. If the outcome is a winning outcome, it will be uniquely displayed. If the outcome is a non-winning outcome, it will be displayed as the preselected set of non-winning outcomes was populated, here all with the same outcome. It should be noted that it is strongly preferred not to make all non-winning outcomes the same in practice as this would reduce the excitement of the game for the player, but it is done in the described embodiment to make clear the fact that the preselected non-winning outcomes need not correspond directly to the complete subset of possible non-winning outcomes other than that all preselected non-winning outcomes used must logically be members of the complete subset of non-winning outcomes. It is preferred to include a number of different non-winning outcomes in the preselected set of non-winning outcomes and it is strongly preferred to use the additional method steps outlined below to generate the preselected set of non-winning outcomes.

In practical terms, the process above would be performed by a computer using standard programming methods and with input from a human being to determine the various parameters. The resulting information would then be stored on a storage medium of any suitable form, whether a CD-ROM, an EPROM, flash RAM, etc. It would then be utilized with a gaming device having the ability to generate random numbers mapping onto the outcome universe. This application contains all information necessary to one of ordinary skill in the art to create such a gaming device and use the outcome of the method with it: all elements of such a machine, absent only the physical embodiment of the outcome of the method and the utilization of a random number to select elements therefrom, are known in the art.

Depending on the size of the set of individual elements which can comprise an outcome and the rules of the individual gambling game, it may be that certain elements will be selected never to be part of a winning outcome. For instance, if the elements are bars, sevens, oranges, and lemons, it might be part of the rules of the gambling game that any combination containing lemons is never a winning outcome. If this is the case, the preselected universe of winning outcomes can be initially configured to ensure no such combination is erroneously assigned a winning payout, and that all or most preselected losing outcomes contain at least one non-winning element.

It is strongly preferred that if the selection of non-winning outcomes is not equivalent to the total subset of non-winning outcomes that the selection of non-winning outcomes be randomly determined by selections of elements in non-winning configurations so as to avoid problems with “lure” prohibitions, which many jurisdictions impose on gambling games, and to make the gambling game's outcomes seem to be determined by randomly selecting individual elements to increase the player's enjoyment.

In an alternative refinement of the method, the gambling machine contains a preselected universe of winning outcomes, but no selection of non-winning outcomes. Consistent with the rules of the gambling game, if the total universe of possible outcomes contains a number N of possible outcomes, with a number M of preselected winning outcomes comprising a subset of N, the gambling game selects a random number from 1 to N. If the number is in the range from 1 to M (M always being equal to or less than N) it is corresponded to a winning outcome in the preselected universe, which is then displayed and acted upon. If the random number is greater than M, the gambling game generates a random non-winning outcome by randomly selecting elements with a selection method which ensures that the final set of elements corresponding to the non-winning outcome is itself not a winning outcome, and displays and acts upon the non-winning outcome. This greatly reduces the size of the preselected universe which must be stored on the gambling game, while causing losing outcomes to be truly random and the actual results of the gambling game to be consistent with the desired payout percentage. Furthermore, if the gambling game's rules contain elements which are non-winning by definition (see above,) the non-winning outcome generation may, although this is neither required nor preferred, include a rule always to include one of these non-winning elements, ensuring that all such displayed outcomes will be non-winning and making it easy and fast for the player to understand that a non-winning outcome has occurred.

While the description above details the preferred and best mode(s) of practicing the invention, many other configurations and variations are possible. For example:

1) The invention need not be practiced with a commercial gaming unit, but could used with a variety of coin-operated amusement devices, home gaming systems, or any other appropriate system.

2) The invention could be incorporated into games which communicate with each other, update in real time, and adjust the odds of winning independently, while using the method of indicating the odds of winning to keep players informed about the gambling game's current status.

3) The symbols used could be actual words or numbers describing with any given level of precision the odds of winning of any given gambling game.

Accordingly, the scope of the invention should be determined not by the embodiment(s) illustrated, but by the claims below and their equivalents.

What is claimed is:

1) A method for selecting a preselected universe of winning outcomes for a gambling game, comprising the steps of:
A) Selecting a fixed size for a selected set of elements;
B) Creating a preselected plurality of possible elements for selection into the selected set of elements;
C) Creating a gambling game having a plurality of fixed rules, the fixed rules determining whether or not the random selection of a particular selected set of elements from the preselected plurality of possible elements produces a winning outcome, and wherein if so one of a plurality of preselected rewards is awarded to a player who is playing the gambling game;
D) Determining a set of all possible winning outcomes based on all possible combinations of selecting the possible elements into the selected set of elements under the fixed rules of the gambling game, the set of all possible winning outcomes having a size;
E) Determining a payout sum of the gambling game, where the payout sum is the sum of all possible payments made under the fixed rules of the gambling game under the set of all possible winning outcomes;
F) Determining a target payout ratio, where the target payout ratio is the ratio between a wager amount made by the player and a desired fraction of the wager account which is to be returned to the player over a statistically significant number of plays of the gambling game, the target payout ratio having a mathematical inverse;
G) Determining an outcome universe size, where the outcome universe size is defined as the mathematical inverse of the target payout ratio multiplied times the size of the set of all possible winning outcomes;
H) Determining a losing outcome universe size, where the losing outcome universe size is defined as the outcome universe size less the size of the set of all possible winning outcomes, and;
I) Creating an outcome universe, the outcome universe comprising all possible winning outcomes and a number of losing outcomes, where the number of losing outcomes is selected so that the outcome universe has the outcome universe size.

2) A gaming machine with a preselected universe of winning outcomes, comprising:
A) A gaming machine having a processor, a random number generator, a set of controls, and a display, where a player can play a gambling game on the gaming machine utilizing the set of controls and viewing the gambling game and an outcome of the gambling game on the display;
B) A storage medium on the gaming machine containing a preselected universe of outcomes for the gambling game, the preselected universe of individual outcomes comprising a mappable set of individual outcomes, the mappable set of individual outcomes further comprising a plurality of discrete winning outcomes with an associated plurality of payouts and a plurality of discrete nonwinning outcomes, whereby the processor can instruct the random number generator to select an outcome-locating random number which is then used to select one of the mappable set of outcomes from the storage medium, and then display to the user on the display an individual outcome corresponding to the outcome-locating random number and, if the individual outcome is one of the plurality of discrete winning outcomes, displaying the associated payout.
